(19) United States
(12) Patent Application Publication
(10) Pub. No.: US 2019/0007656 A1
(43) Pub. Date: Jan. 3, 2019

(54) SENDING NETWORK CAMERA VIDEO STREAMS TO ACTIVE SCREENS

(71) Applicant: Avast Software s.r.o., Praha (CZ)

(72) Inventors: Shaul Levi, Amsterdam (NL); Sushil Kumar Jha, Amstelveen (NL); Ana Silvia Medeira Cabrita, Zaandam (NL)

(21) Appl. No.: 16/024,635

(22) Filed: Jun. 29, 2018

Related U.S. Application Data
(60) Provisional application No. 62/527,350, filed on Jun. 30, 2017.

(51) Int. Cl. H04N 7/18; H04N 7/08; H04N 5/14

(52) U.S. Cl. CPC H04N 7/181; H04N 5/144; H04N 7/0806

(57) ABSTRACT

A camera router application on a router or wireless access point can receive video streams from one more cameras in a home, office, factory or other environment having cameras. The camera router application can receive or detect an event associated with a camera. In response to detecting the event, the camera router application can determine an active screen. The camera router application can router a video stream from the camera to the active screen.

### CROSS-REFERENCE TO RELATED APPLICATIONS

This Application claims priority to U.S. Provisional Patent Application Ser. No. 62/527,350, filed on Jun. 30, 2017, entitled “Sending Network Camera Video Streams to Active Screens,” currently pending, the entire disclosure of which is incorporated herein by reference.

### FIELD

The disclosure relates generally to computer systems and networks, and more particularly, to sending network camera video streams to active screens and monitors through a smart router.

### BACKGROUND

The “Internet of Things” (IoT) is a term used to describe a network comprising many different types of devices, both traditional computers and devices that in the past were not capable of network communication. A “thing” in the IoT can be any type of device that can collect data and communicate data via a network. Examples of such devices include smart home appliances, sensors, biochips, implantable medical devices, and vehicle based devices. An IoT device can provide for control and automation of devices in a smart home, a smart grid, a smart factory, a smart city, an intelligent transportation system etc. As an example, a smart home may have multiple IoT devices that can connect to a home router and can communicate with one another via the home router or access point in the home.

### SUMMARY OF INVENTION

A camera router application on a router or wireless access point can receive video streams from one more cameras in a home, office, factory or other environment having cameras. The camera router application can receive or detect an event associated with a camera. In response to detecting the event, the camera router application can determine an active screen. The camera router application can router a video stream from the camera to the active screen.

### BRIEF DESCRIPTION OF THE DRAWINGS

For a better understanding of the inventive subject matter, reference may be made to the accompanying drawings in which:

FIG. 1 is a block diagram illustrating a system environment for sending network camera streams to an active screen via a router.

FIG. 2 is a flow chart illustrating operations of a method for sending network camera streams to an active screen via a router.

FIG. 3 is a block diagram of an example embodiment of a computer system upon which embodiments of the inventive subject matter can execute.

### DETAILED DESCRIPTION

In the following detailed description of example embodiments of the invention, reference is made to the accompanying drawings that form a part hereof, and in which is shown by way of illustration specific example embodiments in which the invention may be practiced. These embodiments are described in sufficient detail to enable those skilled in the art to practice the inventive subject matter, and it is to be understood that other embodiments may be utilized and that logical, mechanical, electrical and other changes may be made without departing from the scope of the inventive subject matter.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component that appears in multiple Figures. Signals and connections may be referred to by the same reference number or label, and the actual meaning will be clear from its use in the context of the description. In general, the first digit(s) of the reference number for a given item or part of the invention should correspond to the Figure number in which the item or part is first identified.

The description of the various embodiments is to be construed as examples only and does not describe every possible instance of the inventive subject matter. Numerous alternatives could be implemented, using combinations of current or future technologies, which would still fall within the scope of the claims. The following detailed description is, therefore, not to be taken in a limiting sense, and the scope of the inventive subject matter is defined only by the appended claims.

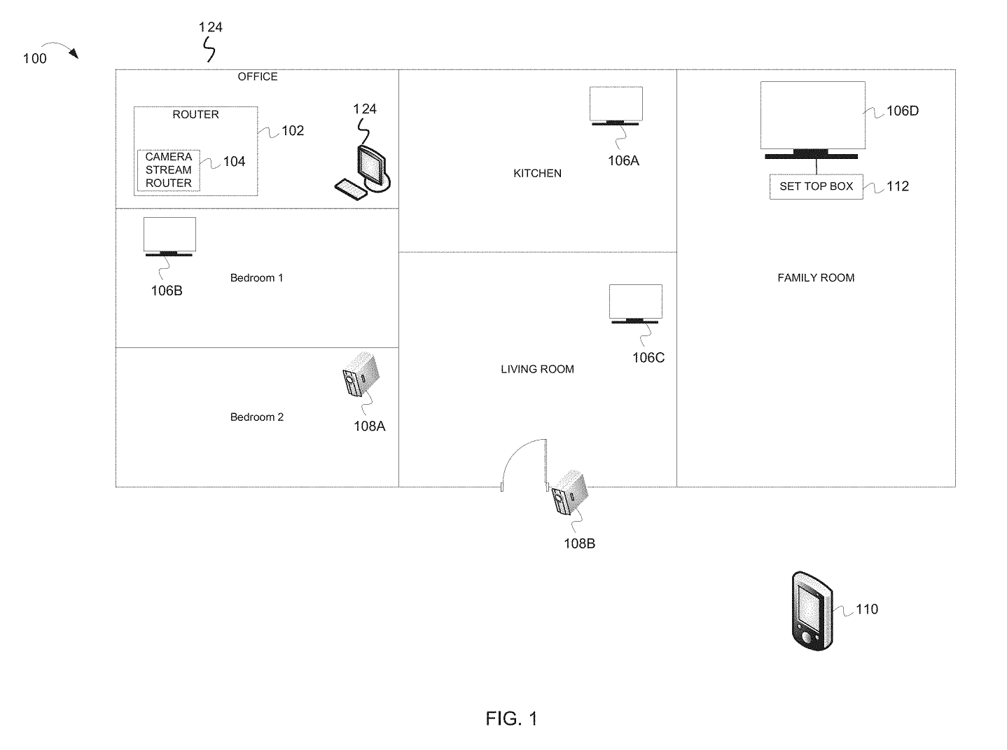

FIG. 1 is a block diagram illustrating a system environment 100 for sending network camera streams to an active screen via a router. In some embodiments, system environment 100 can be a home environment that includes a router 102, one or more cameras (e.g., cameras 108A and 108B), and a plurality of screens. As used herein, a screen can be any kind of display device, screen or monitor that can display a video or other image stream from a camera 108A or 108 B. A screen may be standalone, such as televisions 106A-C, or a screen may be coupled to a smart device such as computer 124, or a set top box 112 coupled to a television 106D. Thus, in the example system environment 100, the screens include televisions 106A-D, a monitor on computer 124, and mobile device 110. Each of these aforementioned devices is, or is coupled to, a display device that can be considered a screen. Cameras 108A and 108B, televisions 106A-D, set top box 112 and computer 124 can be communicably coupled to a wired or wireless network via router 102.

Cameras 108A and 108B can be network connected standalone cameras such as security cameras. Alternatively, cameras 108A and 108B can be integrated with other IoT devices. For example, camera 108A can be a camera integrated with a baby monitor. Camera 108B can be a camera integrated with a doorbell. Other types of IoT devices can include cameras and are within the scope of the inventive subject matter. In some embodiments, a network connected camera 108A and/or 108B can include a microphone. The microphone can be used to detect sound and/or to relay audio information via the network. The camera can also include a speaker to present audio information received from the network. Further, in some embodiments, a network connected camera 108A and/or 108B can include a motion detector. The microphone and motion detector may be used to activate the camera, or detect events associated with the camera. Although two cameras are shown in the example presented in FIG. 1, those of skill in art will appreciate that a system environment 100 may include a single camera or may include more (possibly many more) than two cameras.

Televisions 106A-D can be any type of television that can receive content via a network connection and/or an internal tuner. In some embodiments, televisions 106A-D can be “smart” televisions that can execute application software in addition to receiving television content.

Set top box 112 can include a television tuner and a network interface. Set top box 112 can receive content via a network and can convert the content to output that can be displayed on a television (e.g., television 106D) or other display device that may not have its own network connection or may not be a “smart” television capable of executing applications or other software. The tuner can receive content via a cable television system, a satellite television system, and over-the-air television system, or from a network interface integrated with the set top box 112.

Computer 124 can be any type of computer system, including a desktop computer, a laptop computer, a tablet computer, a server computer etc. that can be communicably coupled to router 102.

Mobile device 110 can be a smart phone, personal digital assistant, music player, tablet computer etc. that can be communicably coupled to router 102.

Router 102 can receive data packets and forward them to the appropriate destination network or computer. For example, in a home environment, a router can receive packets from the Internet, and forward them to nodes on a home network. Router 102 can also route packets from one node on the home network and forward them to another node on the same home network. In some embodiments, router 102 can be an access point of a wireless network. Router 102 can include a camera stream router 104. Camera stream router 104 can acquire and maintain knowledge of cameras and other devices with integrated cameras (e.g., smart phones, tablet computers etc.) that are capable of transmitting video streams in the network. Further, camera stream router 104 can maintain knowledge of screens that can render the video streams received from cameras (e.g., 106A and 106B). Camera stream router 104 can receive or detect events with respect to connected cameras, and in response to such events, select or determine an active screen that is active at the time the event occurs. The camera stream router 104 can route video content from the camera associated with the event to the selected active screen.

Camera stream router 104 can determine the devices on a network in various ways. As an example, camera stream router can use a discovery protocol such as DLNA (Digital Living Network Alliance), OCF (Open Connectivity Foundation) or other protocols to discover devices on the network and the devices characteristics and capabilities.

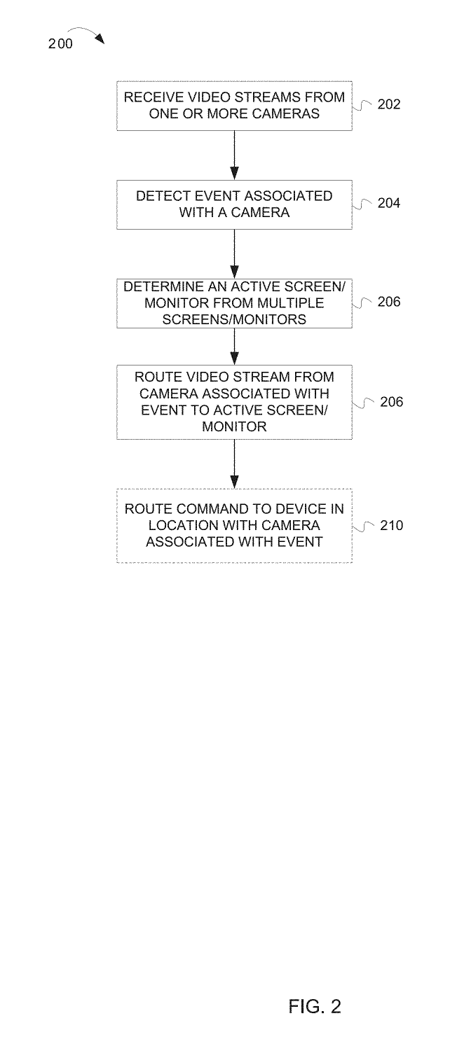

Further details on the operations of devices within system environment 100 are provided below with respect to FIG. 2.

Although system environment 100 has been described in the context of a home environment, in alternative embodiments, system environment 100 can be a business environment, a factory environment, or any other environment having one or more network streaming cameras and multiple screens, one of which that can be selected as an active screen.

FIG. 2 is a flow chart illustrating operations of a method for sending IP camera streams to an active screen via a router. At block 202, a router 102 can receive video streams from one or more cameras. In some embodiments, router 102 can inspect packet data to determine if a data stream is a video stream. For example, the router can parse a packet header to read metadata describing the packet to determine if the packet is part of a video stream. In alternative embodiments, the router 102 can maintain or consult a registry that indicates whether a device that has registered with the router or other registry. The registry can indicate that the device is a camera. The router 102 can use this information to determine that data from the registered device is, or is likely to be, a video stream.

At block 204, the router 102 detects an event associated with a camera. In some embodiments, the event may be provided by the camera in response to the camera detecting motion or a microphone associated with a camera detecting sound. In alternative embodiments, the event may be detected by another device such as an IoT doorbell detecting a press of the doorbell and activating a camera coupled with the IoT doorbell. In further alternative embodiments, the event may be detected at the camera stream router. For example, the camera stream router can include functionality to inspect video streams and/or audio data accompanying video streams. In response to detecting the presence of sound in the audio data, the camera stream router can determine that an event has occurred. Similarly, the camera stream router can compare frames in video data to determine if there has been a change in the capture image that would correspond to motion. In response to detecting the motion, the camera stream router can determine that an event has occurred.

At block 206, the router 102 determines an active screen from one or more screens connected to the router. In some embodiments, the router 102 can determine that a device is an active screen by examining network traffic to and from the devices connected to the router. The router 102 can determine whether or not a device is active by analyzing request/response data transmitted on the network to and from the device. Based on the request/response data (or lack thereof), the router can determine if the device is active or not. As an example, the router may determine whether the request/response data is associated with an application that typically involves user interaction, such as a browser application, document processing application, video/audio player application etc. Further, the router 102 may determine if the device is a device with a screen or monitor. For example, the router 102 may use the MAC address of the device and other available information to determine the type of device. For example, the router 102 may utilize DHCP (Dynamic Host Configuration Protocol) fingerprinting and/or DNS (Domain Name System) analysis to determine the type of device and whether or not it is likely to have a screen or monitor.

At block 208, the router 102 routes the video stream from the camera associated with the event to the active screen determined at block 206 above. The active screen can display the video content received from the camera in addition to, or instead of content that was being displayed just prior to the event at the camera. For example, the video stream from the camera can be provided as an overlay to existing content. Alternatively, the video stream from the camera can be provided as a “picture in a picture.” In some embodiments, the router 102 may use the DIAL (DIscovery And Launch) protocol to cause the video stream from the camera to be displayed on the active screen. For example, the router 102 may used the DIAL protocol to discover devices such as televisions, set top boxes, disc players etc. that can have potentially active screens. After discovery, the router 102 can used the DIAL protocol to cause video streams from a camera to be displayed on the device.

In some embodiments, the router 102 can send the video streams to the most recently active device. In alternative embodiments, the router 102 can send the video streams to all active devices. In further alternative embodiments, the router 102 can send the video streams to active devices of a particular type.

At block 210, the router can optionally receive a command from the active screen, and route the command to the camera or device in which the camera is integrated. For example, in a doorbell camera having an integrated locking device, the router can receive a command from the active screen to lock or unlock the door and can route the command to the appropriate device.

The following examples provide further details on aspects of various embodiments and operating environments.

### Example A

A house can have a smart television and baby camera installed to monitor a baby. In this example, the baby can be sleeping in his/her room and the parents can be watching TV in another room. At any point in time if the baby camera detects movements or sound from the baby, it can trigger a event to the router 102 and camera stream router 104. The camera stream router 104 can determine that the television screen is active and can direct the baby camera stream to the television screen so that the parents are made aware of the situation and can act accordingly.

### Example B

A building (office, warehouse, factory etc.) can have multiple network attached cameras and correspondingly multiple monitors in a security room to display video content from video streams provided by the cameras. It is typically not possible for a security guard to keep an eye on all the monitors to see if there is something suspicious happening. Also, at various times, the security guard may be busy watching a television in a security room or may be using his or her mobile screen. In this case, the router 102 with camera stream router 104 can monitor the video streams coming in and if there is an event triggered corresponding to any suspicious movement or sound, it can direct the video stream to one of the security guard's active screens so that the security guard is made aware of the situation and can act accordingly.

### Example C

A house can have a smart doorbell with an integrated or associated camera. Someone familiar may press the doorbell while the owner is watching television. In this example, the video stream can be displayed on the television and the user can be provided the option of opening the door by providing a signal (via a user interface or remote button) to the television. The television can forward the signal to router 102 and camera stream router 104, which can in turn forward information to the doorbell and cause the door to open. In some embodiments, the doorbell may have an integrated lock/opening mechanism. In alternative embodiments a door associated with the doorbell may have an IoT lock device may be associated with the door. The router 102 can forward instructions to the IoT lock device associated with the same door as the doorbell to cause the IoT lock to unlock the door.

### Example D

A house can have a smart doorbell with an integrated or associated camera with motion detection. If someone tries to get into the house and the owner is busy at the computer, the doorbell can send a signal to the router 102 and redirect the camera video to the computer. The owner of the house can then see who is at the door via the computer monitor and take the necessary measures to prevent the person from entering.

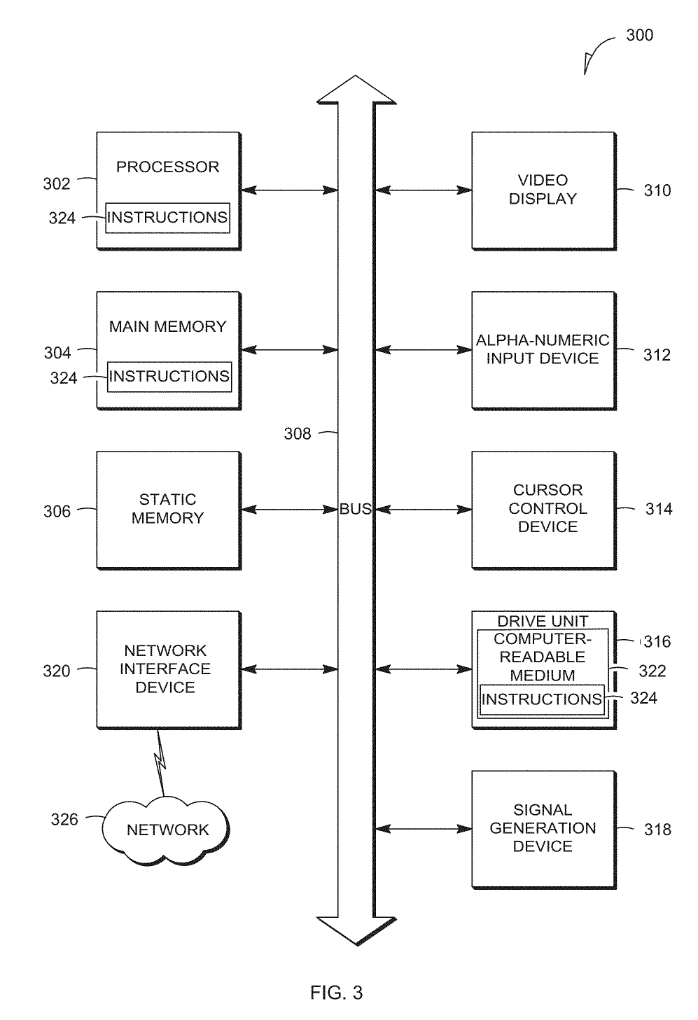

FIG. 3 is a block diagram of an example embodiment of a computer system 300 upon which embodiments of the inventive subject matter can execute. The description of FIG. 3 is intended to provide a brief, general description of suitable computer hardware and a suitable computing environment in conjunction with which the invention may be implemented. In some embodiments, the inventive subject matter is described in the general context of computer-executable instructions, such as program modules, being executed by a computer. Generally, program modules include routines, programs, objects, components, data structures, etc., that perform particular tasks or implement particular abstract data types.

As indicated above, the system as disclosed herein can be spread across many physical hosts. Therefore, many systems and sub-systems of FIG. 3 can be involved in implementing the inventive subject matter disclosed herein.

Moreover, those skilled in the art will appreciate that the invention may be practiced with other computer system configurations, including hand-held devices, multiprocessor systems, microprocessor-based or programmable consumer electronics, smart phones, network PCs, minicomputers, mainframe computers, and the like. Embodiments of the invention may also be practiced in distributed computer environments where tasks are performed by I/O remote processing devices that are linked through a communications network. In a distributed computing environment, program modules may be located in both local and remote memory storage devices.

With reference to FIG. 3, an example embodiment extends to a machine in the example form of a computer system 300 within which instructions for causing the machine to perform any one or more of the methodologies discussed herein may be executed. In alternative example embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. Further, while only a single machine is illustrated, the term “machine” shall also be taken to include any collection of machines that individually or jointly execute a set (or multiple sets) of instructions to perform any one or more of the methodologies discussed herein.

The example computer system 300 may include a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). In example embodiments, the computer system 300 also includes one or more of an alpha-numeric input device 312 (e.g., a keyboard), a user interface (UI) navigation device or cursor control device 314 (e.g., a mouse), a disk drive unit 316, a signal generation device 318 (e.g., a speaker), and a network interface device 320.

The disk drive unit 316 includes a machine-readable medium 322 on which is stored one or more sets of instructions 324 and data structures (e.g., software instructions) embodying or used by any one or more of the methodologies or functions described herein. The instructions 324 may also reside, completely or at least partially, within the main memory 304 or within the processor 302 during execution thereof by the computer system 300, the main memory 304 and the processor 302 also constituting machine-readable media.

While the machine-readable medium 322 is shown in an example embodiment to be a single medium, the term “machine-readable medium” may include a single medium or multiple media (e.g., a centralized or distributed database, or associated caches and servers) that store the one or more instructions. The term “machine-readable medium” shall also be taken to include any tangible medium that is capable of storing, encoding, or carrying instructions for execution by the machine and that cause the machine to perform any one or more of the methodologies of embodiments of the present invention, or that is capable of storing, encoding, or carrying data structures used by or associated with such instructions. The term “machine-readable storage medium” shall accordingly be taken to include, but not be limited to, solid-state memories and optical and magnetic media that can store information in a non-transitory manner, i.e., media that is able to store information. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and CD-ROM and DVD-ROM disks.

The instructions 324 may further be transmitted or received over a communications network 326 using a signal transmission medium via the network interface device 320 and utilizing any one of a number of well-known transfer protocols (e.g., FTP, HTTP). Examples of communication networks include a local area network (LAN), a wide area network (WAN), the Internet, mobile telephone networks, Plain Old Telephone (POTS) networks, and wireless data networks (e.g., WiFi and WiMax networks). The term “machine-readable signal medium” shall be taken to include any transitory intangible medium that is capable of storing, encoding, or carrying instructions for execution by the machine, and includes digital or analog communications signals or other intangible medium to facilitate communication of such software.

Although an overview of the inventive subject matter has been described with reference to specific example embodiments, various modifications and changes may be made to these embodiments without departing from the broader spirit and scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

As is evident from the foregoing description, certain aspects of the inventive subject matter are not limited by the particular details of the examples illustrated herein, and it is therefore contemplated that other modifications and applications, or equivalents thereof, will occur to those skilled in the art. It is accordingly intended that the claims shall cover all such modifications and applications that do not depart from the spirit and scope of the inventive subject matter. Therefore, it is manifestly intended that this inventive subject matter be limited only by the following claims and equivalents thereof.

The Abstract is provided to comply with 37 C.F.R. §1.72(b) to allow the reader to quickly ascertain the nature and gist of the technical disclosure. The Abstract is submitted with the understanding that it will not be used to limit the scope of the claims.

What is claimed is:

1. A method comprising:
receiving, by a camera stream router, one or more video streams from one or more cameras communicably coupled to a router;
detecting an event associated with a camera of the one or more cameras;
determining, by the camera stream router, an active screen from a plurality of screens communicably coupled to the router; and
routing, by the camera stream router a video stream from the camera to the active screen.

2. The method of claim 1, wherein the active screen comprises one of a screen coupled to a computer, a television screen, and a screen of a mobile device.

3. The method of claim 1, wherein the one or more cameras include a camera coupled to a baby monitor, a camera coupled to a doorbell, and a camera coupled to a security system.

4. The method of claim 1, wherein detecting the event associated with the camera comprises detecting one of a motion event or an audio event at the camera.

5. The method of claim 1, wherein determining, by the camera stream router, the active screen comprises determining presence of network request and network response data associated with a device coupled to the active screen.

6. The method of claim 5, wherein determining the presence of network request and network response data comprises determining the presence of network request and network response data associated with user interaction with an application on the device. The method of claim 1, wherein determining, by the camera stream router, the active screen comprises determining that a device coupled to the active screen is configured with a screen or monitor.

8. A machine-readable storage medium having stored thereon computer-executable instructions that, when executed, cause a router to perform operations comprising:
receive one or more video streams from one or more cameras communicably coupled to the router;
detect an event associated with a camera of the one or more cameras;
determine an active screen from a plurality of screens communicably coupled to the router; and
route a video stream from the camera to the active screen.

9. The machine-readable storage medium of claim 8, wherein the one or more cameras include a camera coupled to a baby monitor, a camera coupled to a doorbell, and a camera coupled to a security system.

10. The machine-readable storage medium of claim 8, wherein the computer-executable instructions to detect the event associated with the camera comprise computer-executable instructions to detect one of a motion event or an audio event at the camera.

11. The machine-readable storage medium of claim 8, wherein the computer-executable instructions to determine the active screen comprise computer-executable instructions to determine presence of network request and network response data associated with a device coupled to the active screen.

12. The machine-readable storage medium of claim 11, wherein the computer-executable instructions to determine the presence of network request and network response data comprise computer-executable instructions to determine the presence of network request and network response data associated with user interaction with an application on the device.

13. The machine-readable storage medium of claim 8, wherein the computer-executable instructions to determine the active screen comprise computer-executable instructions to determine that a device coupled to the active screen is configured with a screen or monitor.

14. A router comprising:
one or more processors; and
a machine-readable storage medium having stored thereon computer-executable instructions that, when executed, cause the router to perform operations comprising:
receive one or more video streams from one or more cameras communicably coupled to the router;
detect an event associated with a camera of the one or more cameras;
determine an active screen from a plurality of screens communicably coupled to the router; and
route a video stream from the camera to the active screen.

15. The router of claim 14, wherein the active screen comprises one of a screen coupled to a computer, a television screen, and a screen of a mobile device.

16. The router of claim 14, wherein the one or more cameras include a camera coupled to a baby monitor, a camera coupled to a doorbell, and a camera coupled to a security system.

17. The router of claim 14, wherein the computer-executable instructions to detect the event associated with the camera comprise computer-executable instructions to detect one of a motion event or an audio event at the camera.

18. The router of claim 14, wherein the computer-executable instructions to determine the active screen comprise computer-executable instructions to determine presence of network request and network response data associated with a device coupled to the active screen.

19. The router of claim 18, wherein the computer-executable instructions to determine the presence of network request and network response data comprise computer-executable instructions to determine the presence of network request and network response data associated with user interaction with an application on the device.

20. The router of claim 14, wherein the computer-executable instructions to determine the active screen comprise computer-executable instructions to determine that a device coupled to the active screen is configured with a screen or monitor.
